(19) United States
(12) Patent Application Publication
(10) Pub. No.: US 2025/0306360 A1
(43) Pub. Date: Oct. 2, 2025

(54) FUNDUS PHOTOGRAPHY DEVICE, ELECTRONIC DEVICE AND AUTOMATIC DIRT DETECTION METHOD

(71) Applicants: Acer Incorporated, New Taipei City (TW); Acer Medical Inc., NEW TAIPEI CITY (TW)

(72) Inventors: Yi-Jin HUANG, New Taipei City (TW); Wei-Hao CHANG, New Taipei City (TW); Chien-Hung LI, New Taipei City (TW); Meng-Che CHENG, New Taipei City (TW)

(73) Assignees: Acer Incorporated, New Taipei City (TW); Acer Medical Inc., NEW TAIPEI CITY (TW)

(21) Appl. No.: 19/079,188

(22) Filed: Mar. 13, 2025

(30) Foreign Application Priority Data
Mar. 26, 2024 (TW) 113111230

(51) Int. Cl. G02B 27/00; H04N 23/86

(52) U.S. Cl. CPC G02B 27/0006; H04N 23/86

(57) ABSTRACT

A fundus photography device, an electronic device and an automatic dirt detection method are provided. The automatic dirt detection method includes the following steps. A first fundus image is obtained. A saturation channel is used to obtain a first object box from the first fundus image. A second fundus image is obtained. Grayscale values of the first fundus image and the second fundus image corresponding the first object box are compared to obtain a first correlation coefficient. If the first correlation coefficient is greater than a correlation coefficient threshold, the fundus photography device is deemed that there is a dirt. Contour contents of the first fundus image and the second fundus image corresponding the first object box are compared to obtain a first similarity index. If the first similarity index is greater than a similarity threshold, the fundus photography device is deemed that there is a dirt.

This application claims the benefit of Taiwan application Serial No. 113111230, filed Mar. 26, 2024, the disclosure of which is incorporated by reference herein in its entirety.

### TECHNICAL FIELD

The disclosure relates in general to an electronic device and a detection method, and more particularly to a fundus photography device, an electronic device and an automatic dirt detection method.

### BACKGROUND

In current medical technology, fundus photography can be used to examine eye diseases. Since the structure of the eyeball is very delicate, the fundus photography device used is also relatively sophisticated.

Therefore, even small amounts of dirt attached to the fundus photography device will greatly affect the interpretation of the fundus photography results. How to detect dirt immediately during the inspection process and remove them immediately to avoid the impact of dirt on the inspection results, so that the inspection results can be accurately interpreted, is actually the direction of research and development in the industry.

### SUMMARY

The disclosure is directed to a fundus photography device, an electronic device and an automatic dirt detection method. The comparison of fundus images is used to automatically detect the dirt on the lens of the device to avoid the dirt on the lens from affecting the correct interpretation of the examination.

According to one embodiment, an automatic dirt detection method for a fundus photography device is provided. The automatic dirt detection method includes the following steps. A first fundus image is obtained. A first object box is obtained from the first fundus image via a saturation channel. A second fundus image is obtained. Grayscale values of the first fundus image corresponding the first object box and grayscale values of the second fundus image corresponding the first object box are compared, to obtain a first correlation coefficient. If the first correlation coefficient is greater than a correlation coefficient threshold, it is deemed that there is a dirt on the fundus photography device. Contour contents of the first fundus image corresponding the first object box and contour contents of the second fundus image corresponding the first object box are compared, to obtain a first similarity index. If the first similarity index is greater than a similarity threshold, it is deemed that there is a dirt on the fundus photography device.

According to another embodiment, an electronic device is provided. The electronic device includes an input unit, a storage unit, an object box creation unit, a grayscale matching unit, a contour matching unit and a determination unit. The input unit is used to input a first fundus image and a second fundus image. The storage unit is used to store the first fundus image and the second fundus image. The object box creation unit is used to obtain a first object box from the first fundus image via a saturation channel. The grayscale matching unit is used to compare grayscale values of the first fundus image corresponding the first object box and grayscale values of the second fundus image corresponding the first object box, to obtain a first correlation coefficient. The contour matching unit is used to compare contour contents of the first fundus image corresponding the first object box and contour contents of the second fundus image corresponding the first object box, to obtain a first similarity index. If the first correlation coefficient is greater than a correlation coefficient threshold, the determination unit deems that there is a dirt on the fundus photography device; if the first similarity index is greater than a similarity threshold, the determination unit deems that there is a dirt on the fundus photography device.

According to an alternative embodiment, a fundus photography device is provided. The fundus photography device includes an image capturing unit, a storage unit, an object box creation unit, a grayscale matching unit, a contour matching unit and a determination unit. The image capturing unit is used to capture a first fundus image and a second fundus image. The storage unit is used to temporarily store the first fundus image and the second fundus image. The object box creation unit is used to obtain a first object box from the first fundus image via a saturation channel. The grayscale matching unit is used to compare grayscale values of the first fundus image corresponding the first object box and grayscale values of the second fundus image corresponding the first object box, to obtain a first correlation coefficient. The contour matching unit is used to compare contour contents of the first fundus image corresponding the first object box and contour contents of the second fundus image corresponding the first object box, to obtain a first similarity index. If the first correlation coefficient is greater than a correlation coefficient threshold, the determination unit deems that there is a dirt on the fundus photography device; if the first similarity index is greater than a similarity threshold, the determination unit deems that there is a dirt on the fundus photography device.

### BRIEF DESCRIPTION OF THE DRAWINGS

FIG. 1 illustrates a schematic diagram of a fundus photography device and an electronic device according to an embodiment of the present disclosure.

FIG. 2 illustrates an example of the automatic dirt detection method of the fundus photography device according to an embodiment of the present disclosure.

FIG. 3 illustrates a block diagram of an electronic device according to an embodiment of the present disclosure.

FIG. 4 illustrates a flow chart of the automatic dirt detection method of the fundus photography device according to an embodiment of the present disclosure.

FIG. 5 illustrates the step S130.

FIG. 6 illustrates the steps S140, S150, S160.

FIGS. 7A to 7C illustrate a flow chart of the automatic dirt detection method of the fundus photography device according to another embodiment of the present disclosure.

FIG. 8 illustrates steps S140, S150, S140′, S150′, S160′.

FIG. 9 illustrates a block diagram of a fundus photography device according to another embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

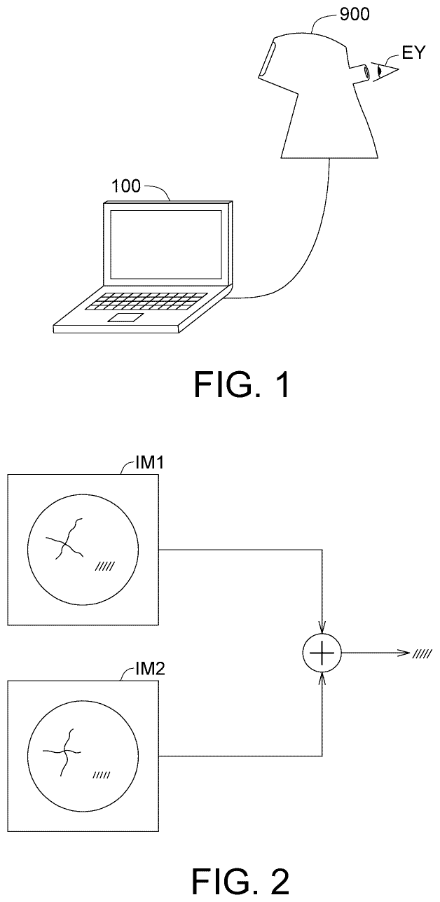

FIG. 1 illustrates a schematic diagram of a fundus photography device 900 and an electronic device 100 according to an embodiment of the present disclosure. In this disclosure, the fundus photography device 900 is used to examine the fundus photography of the subject's eyeball EY. Since the internal structure of the human eye is very delicate, it is easy for small dirt to adhere to the lens of the fundus photography device 900 during the inspection process. When the inspection results are sent to the electronic device 100 for interpretation, the dirt on the lens will cover the image and affect the interpretation.

Please refer to FIG. 2, which illustrates an example of the automatic dirt detection method of the fundus photography device 900 according to an embodiment of the present disclosure. In this disclosure, the comparison is based on a first fundus image IM1 and a second fundus image IM2 of the subject. When similar patterns appear in the two images, the operator is reminded that the lens of the fundus photography device 900 is dirty, so that the operator can immediately clean the lens and re-examine the subject to obtain accurate eyeball inspection results.

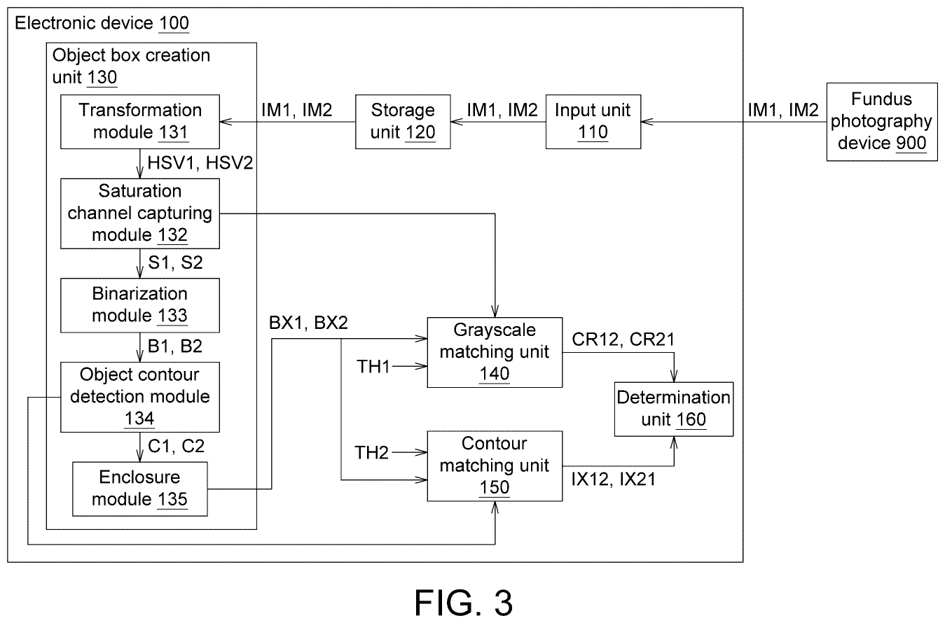

Please refer to FIG. 3, which illustrates a block diagram of an electronic device 100 according to an embodiment of the present disclosure. The electronic device 100 includes an input unit 110, a storage unit 120, an object box creation unit 130, a grayscale matching unit 140, a contour matching unit 150 and a determination unit 160. The input unit 110 is used to input the first fundus image IM1 and the second fundus image IM2.

The storage unit 120 is used to store the first fundus image IM1 and the second fundus image IM2. The storage unit 120 is, for example, any type of fixed or removable random access memory (RAM), read-only memory (ROM), flash memory, hard disk drive (HDD), solid state drive (SSD) or similar components or a combination of the above components, and is used to store multiple modules or various applications that can be executed by the processor.

The object box creation unit 130 includes a transformation module 131, a saturation channel capturing module 132, a binarization module 133, an object contour detection module 134 and an enclosure module 135.

The object box creation unit 130, the grayscale matching unit 140, the contour matching unit 150 and/or the determination unit 160 is, for example, a circuit, a circuit board, a storage device storing program codes or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

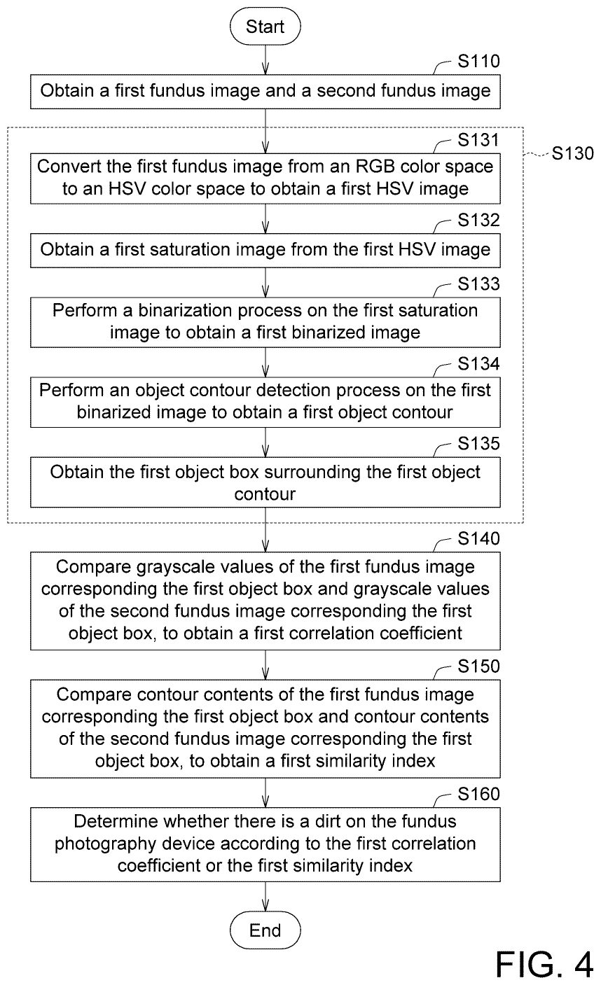

Please refer to FIG. 4, which illustrates a flow chart of the automatic dirt detection method of the fundus photography device 900 according to an embodiment of the present disclosure. The automatic dirt detection method of fundus photography device 900 includes step S110 to step S160.

In the step S110, the input unit 110 of the electronic device 100 obtains the first fundus image IM1 and the second fundus image IM2 from the fundus photography device 900. The first fundus image IM1 and the second fundus image IM2 are stored in the storage unit 120. The first fundus image IM1 and the second fundus image IM2 could be fundus images of different eyeballs of the same subject, or they could be fundus images of different subjects.

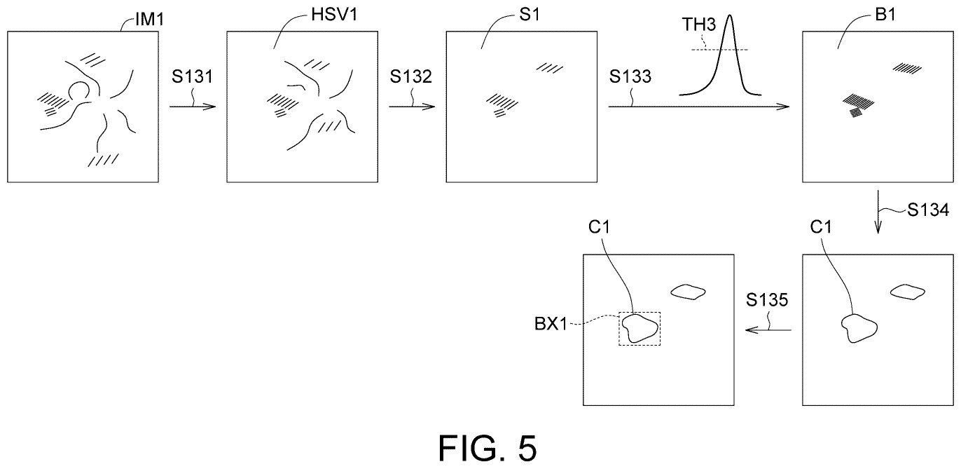

Please refer to FIG. 3, FIG. 4 and FIG. 5 at the same time. FIG. 5 illustrates the step S130. In the step S130, the object box creation unit 130 uses a saturation channel to obtain a first object box BX1 from the first fundus image IM1. The steps of obtaining the first object box BX1 include step S131 to step S135.

In the step S131, as shown in the FIG. 5, the transformation module 131 converts the first fundus image IM1 from an RGB color space to an HSV color space to obtain a first HSV image HSV1.

Then, in the step S132, as shown in the FIG. 5, the saturation channel capturing module 132 obtains a first saturation image S1 from the first HSV image HSV1.

Next, in the step S133, as shown in the FIG. 5, the binarization module 133 performs a binarization process on the first saturation image S1 to obtain a first binarized image B1. The binarization module 133 performs the binarization process with a grayscale threshold TH3. The grayscale threshold TH3 is, for example, half of the saturation mode of the first saturation image S1.

In the step S134, as shown in the FIG. 5, the object contour detection module 134 performs an object contour detection process on the first binarized image B1 to obtain a first object contour C1. The object contour detection module 134 detects the edge of the largest connected area in the first binarized image B1 as the first object contour C1.

Next, in the step S135, as shown in FIG. 5, the enclosure module 135 creates the first object box BX1 that surrounds the first object contour C1.

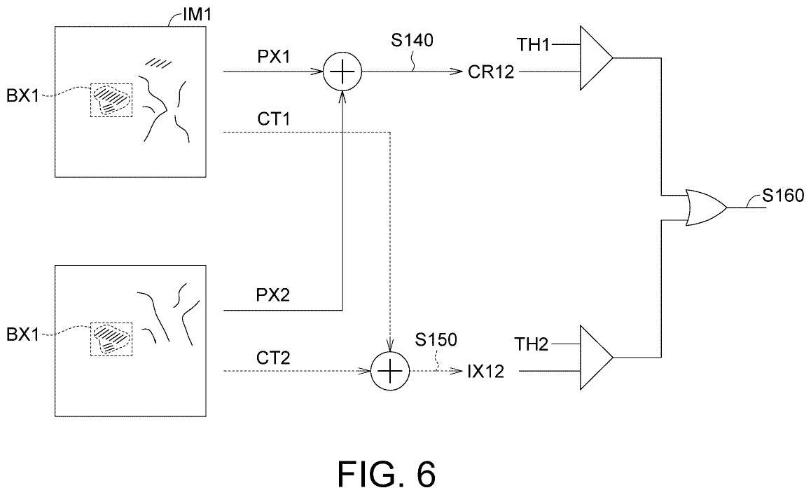

Then, please refer to FIG. 3, FIG. 4 and FIG. 6 at the same time. FIG. 6 illustrates the steps S140, S150, S160. In the step S140, as shown in the FIG. 6, the grayscale matching unit 140 compares the grayscale values PX1 of the first fundus image IM1 corresponding the first object box BX1 with the grayscale values PX2 of the second fundus image IM2 corresponding the first object box BX1 to obtain a first correlation coefficient CR12. In one embodiment, the grayscale value PX1 and the grayscale value PX2 are, for example, the grayscale values of saturation.

In the step S150, as shown in the FIG. 6, the contour matching unit 150 compares the contour content CT1 of the first fundus image IM1 corresponding the first object box BX1 with the contour content CT2 of the second fundus image IM2 corresponding the first object box BX1 to obtain a first similarity index IX12.

In one embodiment, the contour matching unit 150 obtains the contour content CT1 of the first fundus image IM1 corresponding the first object box BX1 and the contour content CT2 of the second fundus image IM2 corresponding the first object box BX1 through a binarization process and an object contour detection process.

In the step S160, as shown in the FIG. 6, if the first correlation coefficient CR12 in the first object box BX1 is greater than a correlation coefficient threshold TH1, the determination unit 160 determines that the fundus photography device 900 is dirty. Or, if the first similarity index IX12 in the first object box BX1 is greater than a similarity threshold TH2, the determination unit 160 also determines that the fundus photography device 900 is dirty.

According to the above embodiment, when the user operates the fundus photography device 900, the user can determine whether there is a dirt on the fundus photography device 900 by comparing the similarity of the grayscale values of the saturations or the contour contents of the first fundus image IM1 and the second fundus image IM2 corresponding the first object box BX1, so that the dirt can be removed immediately, and the subject can be re-examined immediately to avoid dirt affecting the interpretation results.

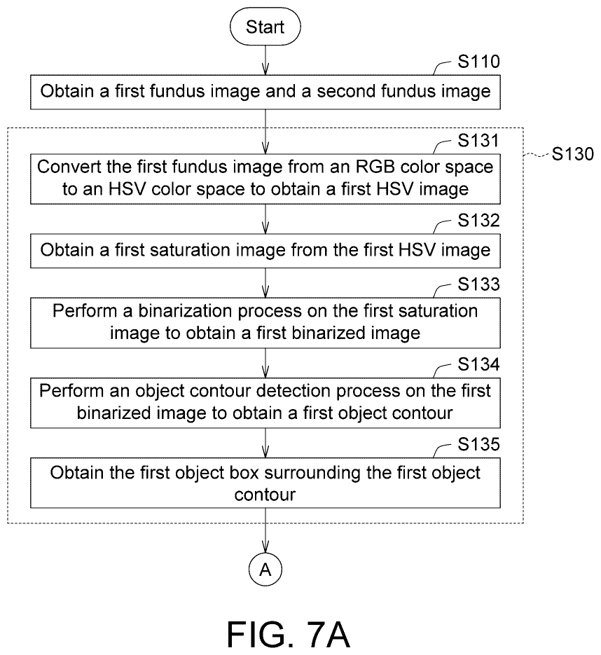

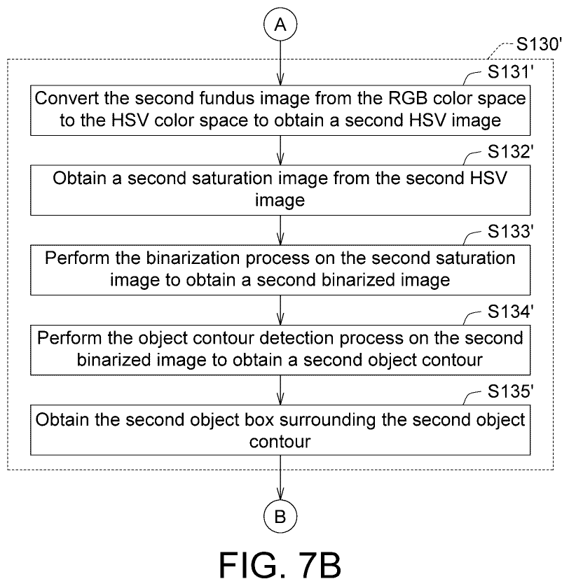

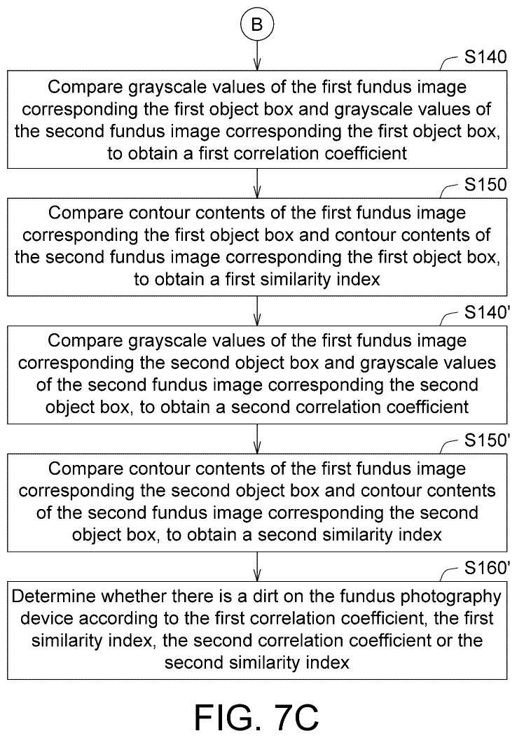

Please refer to FIGS. 7A to 7C, which illustrate a flow chart of the automatic dirt detection method of the fundus photography device 900 according to another embodiment of the present disclosure. In another embodiment, the automatic dirt detection method of the fundus photography device 900 can simultaneously compare the contents of the first fundus image IM1 and the second fundus image IM2 corresponding the first object box BX1 and the second object box BX2. The first object box BX1 comes from the first fundus image IM1; the second object box BX2 comes from the second fundus image IM2, and the two are not necessarily the same. The comparison method is further explained below.

The steps of obtaining the first object box BX1, as described in the step S110 to the step S130 above, which will not be described again here. The following instructions the step S130′ of obtaining the second object box BX2 from the second fundus image IM2.

In the step S130′, the object box creation unit 130 uses the saturation channel to obtain the second object box BX2 from the second fundus image IM2. The step S130′ of obtaining the second object box BX2 includes step S131′ to step S135′

Then, in the step S131′, as shown in the FIG. 3, the transformation module 131 converts the second fundus image IM2 from the RGB color space to the HSV color space to obtain a second HSV image HSV2.

In the step S132′, as shown in the FIG. 3, the saturation channel capturing module 132 obtains a second saturation image S2 from the second HSV image HSV2.

Then, in the step S133′, as shown in the FIG. 3, the binarization module 133 performs the binarization process on the second saturation image S2 to obtain a second binarized image B2.

In the step S134′, as shown in the FIG. 3, the object contour detection module 134 performs the object contour detection process on the second binarized image B2 to obtain a second object contour C2.

Next, in the step S135′, as shown in the FIG. 3, the enclosure module 135 creates the second object box BX2 that surrounds the second object contour C2.

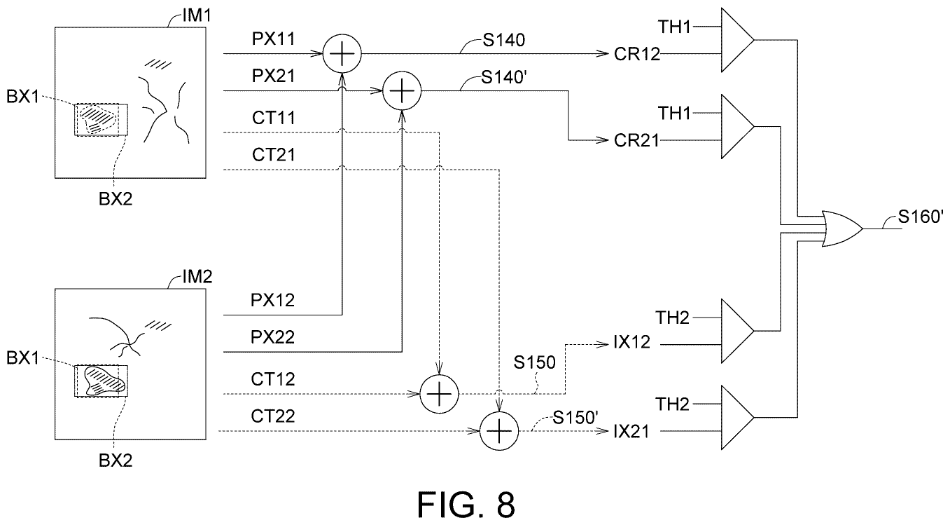

Then, please refer to FIG. 3, FIGS. 7A to 7C and FIG. 8 at the same time. FIG. 8 illustrates steps S140, S150, S140′, S150′, S160′. In the step S140, the grayscale matching unit 140 compares the grayscale value PX11 of the first fundus image IM1 corresponding the first object box BX1 with the grayscale value PX12 of the second fundus image IM2 corresponding the first object box BX1 to obtain the first correlation coefficient CR12.

In the step S150, the contour matching unit 150 compares the contour content CT11 of the first fundus image IM1 corresponding the first object box BX1 with the contour content CT12 of the second fundus image IM2 corresponding the first object box BX1 to obtain the first similarity index IX12.

In the step S140′, the grayscale matching unit 140 compares the grayscale value PX21 of the first fundus image IM1 corresponding the second object box BX2 with the grayscale value PX22 of the second fundus image IM2 corresponding the second object box BX2 to obtain a second correlation coefficient CR21.

In the step S150′, the contour matching unit 150 compares the contour content CT21 of the first fundus image IM1 corresponding the second object box BX2 with the contour content CT22 of the second fundus image IM2 corresponding the second object box BX2 to obtain a second similarity index IX21.

Next, in the step S160′, if the first correlation coefficient CR12 is greater than the correlation coefficient threshold TH1 or the second correlation coefficient CR21 is greater than the correlation coefficient threshold TH1, the determination unit 160 determines that the fundus photography device 900 is dirty.

Or, in the step S160′, if the first similarity index IX12 is greater than a similarity threshold TH2 or the second similarity index IX21 is greater than a similarity threshold TH2, the determination unit 160 will also determine that the fundus photography device 900 is dirty.

That is to say, whether in the first object box BX1 or the second object box BX2, as long as either the first correlation coefficient CR12 and the second correlation coefficient CR21 are greater than the correlation coefficient threshold TH1, or either the first similarity index IX12 and the second similarity index IX21 are greater than the similarity threshold TH2, the fundus photography device 900 is determined to be dirty. Then, the electronic device 100 will send a signal to notify the operator to remove the dirt on the fundus photography device 900 and then re-inspect it.

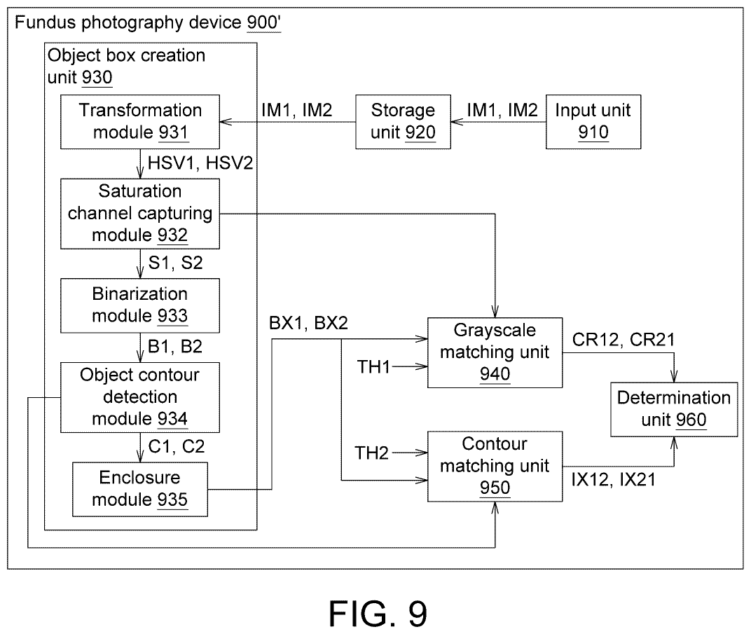

Please refer to FIG. 9, which illustrates a block diagram of a fundus photography device 900′ according to another embodiment of the present disclosure. In another embodiment, the fundus photography device 900′ includes an image capturing unit 910, a storage unit 920, an object box creation unit 930, a grayscale matching unit 940, a contour matching unit 950 and a determination unit 960. The image capturing unit 910 is used to capture the first fundus image IM1 and the second fundus image IM2. The storage unit 920 is used to temporarily store the first fundus image IM1 and the second fundus image IM2. The automatic dirt detection method of the fundus photography device 900′ is the same as the above step, which will not be described again here.

In this embodiment, the fundus photography device 900′ has the function of directly determining whether there is contamination. During the inspection process, since the storage unit 920 temporarily stores the first fundus image IM1 and the second fundus image IM2, it can directly determine whether the captured image is contaminated during the inspection process. There is no need to transmit the inspection image to the electronic device 100 for interpretation, which shortens the time for determining whether there is contamination.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A automatic dirt detection method for a fundus photography device, comprising:
obtaining a first fundus image;
obtaining a first object box from the first fundus image via a saturation channel;
obtaining a second fundus image;
comparing grayscale values of the first fundus image corresponding the first object box and grayscale values of the second fundus image corresponding the first object box, to obtain a first correlation coefficient;
deeming that there is a dirt on the fundus photography device, if the first correlation coefficient is greater than a correlation coefficient threshold;
comparing contour contents of the first fundus image corresponding the first object box and contour contents of the second fundus image corresponding the first object box, to obtain a first similarity index; and
deeming that there is a dirt on the fundus photography device, if the first similarity index is greater than a similarity threshold.

2. The automatic dirt detection method for the fundus photography device according to claim 1, wherein the step of obtaining the first object box includes:
converting the first fundus image from an RGB color space to an HSV color space to obtain a first HSV image;
obtaining a first saturation image from the first HSV image;
performing a binarization process on the first saturation image to obtain a first binarized image;
performing an object contour detection process on the first binarized image to obtain a first object contour; and
obtaining the first object box surrounding the first object contour.

3. The automatic dirt detection method for the fundus photography device according to claim 2, wherein in the binarization process on the first saturation image, the binarization process is performed with a grayscale threshold, and the grayscale threshold is half of a saturation mode of the first saturation image.

4. The automatic dirt detection method for the fundus photography device according to claim 2, wherein in the object contour detection process on the first binarized image, an edge of a largest connected area in the first binarized image is detected as the first object contour.

5. The automatic dirt detection method for the fundus photography device according to claim 2, further comprising:
obtaining, via the saturation channel, a second object box from the second fundus image;
comparing grayscale values of the first fundus image corresponding the second object box and grayscale values of the second fundus image corresponding the second object box, to obtain a second correlation coefficient;
deeming that there is the dirt on the fundus photography device, if the second correlation coefficient is greater than the correlation coefficient threshold;
comparing contour contents of the first fundus image corresponding the second object box and contour contents of the second fundus image corresponding the second object box, to obtain a second similarity index; and
deeming that there is the dirt on the fundus photography device, if the second similarity index is greater than the similarity threshold.

6. The automatic dirt detection method for the fundus photography device according to claim 5, wherein the step of obtaining the second object box comprises:
converting the second fundus image from the RGB color space to the HSV color space to obtain a second HSV image;
obtaining a second saturation image from the second HSV image;
performing the binarization process on the second saturation image to obtain a second binarized image;
performing the object contour detection process on the second binarized image to obtain a second object contour; and
obtaining the second object box surrounding the second object contour.

7. The automatic dirt detection method for the fundus photography device according to claim 1, wherein in the step of comparing the grayscale values of the first fundus image corresponding the first object box and the grayscale values of the second fundus image corresponding the first object box, the grayscale values of saturation of the first fundus image corresponding the first object box and the grayscale values of saturation of the second fundus image corresponding the first object box are compared.

8. The automatic dirt detection method for the fundus photography device according to claim 1, wherein in the step of comparing the contour contents of the first fundus image corresponding the first object box and the contour contents of the second fundus image corresponding the first object box, the contour contents of the first fundus image corresponding the first object box and the contour contents of the second fundus image corresponding the first object box are obtained through a binarization process and an object contour detection process.

9. An electronic device, comprising:
an input unit, used to input a first fundus image and a second fundus image;
a storage unit, used to store the first fundus image and the second fundus image;
an object box creation unit, used to obtain a first object box from the first fundus image via a saturation channel;
a grayscale matching unit, used to compare grayscale values of the first fundus image corresponding the first object box and grayscale values of the second fundus image corresponding the first object box, to obtain a first correlation coefficient;
a contour matching unit, used to compare contour contents of the first fundus image corresponding the first object box and contour contents of the second fundus image corresponding the first object box, to obtain a first similarity index; and
a determination unit, wherein if the first correlation coefficient is greater than a correlation coefficient threshold, the determination unit deems that there is a dirt on the fundus photography device; if the first similarity index is greater than a similarity threshold, the determination unit deems that there is a dirt on the fundus photography device.

10. The electronic device according to claim 9, wherein the object box creation unit includes:
a transformation module, used to convert the first fundus image from an RGB color space to an HSV color space to obtain a first HSV image;
a saturation channel capturing module, used to obtain a first saturation image from the first HSV image;
a binarization module, used to perform a binarization process on the first saturation image to obtain a first binarized image;
an object contour detection module, used to perform an object contour detection process on the first binarized image to obtain a first object contour; and
an enclosure module, used to obtain the first object box surrounding the first object contour.

11. The electronic device according to claim 10, wherein the binarization module performs the binarization process with a grayscale threshold, and the grayscale threshold is half of a saturation mode of the first saturation image.

12. The electronic device according to claim 10, wherein the object contour detection module detects an edge of a largest connected area in the first binarized image as the first object contour.

13. The electronic device according to claim 10, wherein the grayscale matching unit compares the grayscale values of saturation of the first fundus image corresponding the first object box and the grayscale values of saturation of the second fundus image corresponding the first object box.

14. The electronic device according to claim 10, wherein
the object box creation unit further obtains a second object box from the second fundus image;
the grayscale matching unit further compares grayscale values of the first fundus image corresponding the second object box and grayscale values of the second fundus image corresponding the second object box, to obtain a second correlation coefficient;
the contour matching unit further compares contour contents of the first fundus image corresponding the second object box and contour contents of the second fundus image corresponding the second object box, to obtain a second similarity index;
if the second correlation coefficient is greater than the correlation coefficient threshold, the determination unit deems that there is the dirt on the fundus photography device; and
if the second similarity index is greater than the similarity threshold, the determination unit deems that there is the dirt on the fundus photography device.

15. The electronic device according to claim 14, wherein
the transformation module is further used to convert the second fundus image from the RGB color space to the HSV color space to obtain a second HSV image;
the saturation channel capturing module is further used to obtain a second saturation image from the second HSV image;
the binarization module is further used to perform the binarization process on the second saturation image to obtain a second binarized image;
the object contour detection module is further used to perform the object contour detection process on the second binarized image to obtain a second object contour; and
the enclosure module is further used to obtain the second object box surrounding the second object contour.

16. The electronic device according to claim 14, wherein the contour matching unit obtains the contour content of the first fundus image corresponding the first object box and the contour content of the second fundus image corresponding the first object box through the binarization process and the object contour detection process.

17. A fundus photography device, comprises:
an image capturing unit, used to capture a first fundus image and a second fundus image;
a storage unit, used to temporarily store the first fundus image and the second fundus image;
an object box creation unit, used to obtain a first object box from the first fundus image via a saturation channel;
a grayscale matching unit, used to compare grayscale values of the first fundus image corresponding the first object box and grayscale values of the second fundus image corresponding the first object box, to obtain a first correlation coefficient;
a contour matching unit, used to compare contour contents of the first fundus image corresponding the first object box and contour contents of the second fundus image corresponding the first object box, to obtain a first similarity index; and
a determination unit, wherein if the first correlation coefficient is greater than a correlation coefficient threshold, the determination unit deems that there is a dirt on the fundus photography device; if the first similarity index is greater than a similarity threshold, the determination unit deems that there is a dirt on the fundus photography device.

18. The fundus photography device according to claim 17, wherein the object box creation unit comprises:
a transformation module, used to convert the first fundus image from an RGB color space to an HSV color space to obtain a first HSV image;
a saturation channel capturing module, used to obtain a first saturation image from the first HSV image;
a binarization module, used to perform a binarization process on the first saturation image to obtain a first binarized image;
an object contour detection module, used to perform an object contour detection process on the first binarized image to obtain a first object contour; and
an enclosure module, used to obtain the first object box surrounding the first object contour.

19. The fundus photography device according to claim 17, wherein
the object box creation unit further obtains a second object box from the second fundus image;
the grayscale matching unit further compares grayscale values of the first fundus image corresponding the second object box and grayscale values of the second fundus image corresponding the second object box, to obtain a second correlation coefficient;
the contour matching unit further compares contour contents of the first fundus image corresponding the second object box and contents of the second fundus image corresponding the second object box, to obtain a second similarity index;
if the second correlation coefficient is greater than the correlation coefficient threshold, the determination unit deems that there is the dirt on the fundus photography device; and
if the second similarity index is greater than the similarity threshold, the determination unit deems that there is the dirt on the fundus photography device.

20. The fundus photography device according to claim 17, wherein
the transformation module is further used to convert the second fundus image from the RGB color space to the HSV color space to obtain a second HSV image;
the saturation channel capturing module is further used to obtain a second saturation image from the second HSV image;
the binarization module is further used to perform the binarization process on the second saturation image to obtain a second binarized image;
the object contour detection module is further used to perform the object contour detection process on the second binarized image to obtain a second object contour; and
the enclosure module is further used to obtain the second object box surrounding the second object contour.
